(19) United States
(12) Patent Application Publication
(10) Pub. No.: US 2024/0141168 A1
(43) Pub. Date: May 2, 2024

(54) INDUSTRIAL PLASTELINE AND USE THEREOF

(71) Applicant: STAEDTLER MARS GMBH & CO. KG, Nürnberg (DE)

(72) Inventors: Johannes NACHTMANN, Neumarkt (DE); Patrick HÖRNING, Erlangen (DE)

(21) Appl. No.: 18/279,484

(22) PCT Filed: Mar. 15, 2021
(86) PCT No.: PCT/EP2021/025104

§ 371 Date: Aug. 30, 2023

(51) Int. Cl. C08L 91/06

(52) U.S. Cl. CPC C08L 91/06

(57) ABSTRACT

Plasteline, including a binder and a filler, and at least one surfactant.

The invention relates to a plasteline, or industrial plasteline, and the use thereof.

Plasteline or clays for forming and modelling are known in principle. For example, use is made of mixtures comprising mineral and organic fillers and binders.

Such plasteline or clay or styling-clay find use in car modelling.

Clays for the design process of car makers must comprise a plurality of properties/parameters in order to achieve satisfactory work results. For the construction of a model, clays are first heated in a heating oven to a temperature of approximately 60° C. and then applied manually or by machine onto a substructure. In order to enable this, such materials have to be plastically deformable and have a low penetration hardness.

After the application of the clay on the substructure, the clay begins to cool down, which is accompanied by an increase in hardness. The increase in hardness is caused by components of the clay, which have a phase transition from liquid to solid between 60° C. and room temperature. Such components can be present as wax and/or vaseline.

If, for example, the solidification range of the waxes is reached during the cooling of the clay, the waxes at the surface start to become increasingly brittle. This change can be checked, whereby a sample is removed from the oven at 60° C. and kneaded by hand until such time as a marked crack formation occurs at the surface.

A drawback is to be seen here in that superficially brittle clay can no longer be applied to form a homogeneous layer on the substructure or model.

The timespan for the possible processing is referred to as a time window for the application or as a duration of malleability.

A further step for the processing of the clay now cooled down to room temperature is the process of machining down, which first takes place mechanically by milling and then manually, with increasingly fine planing, scrapers and blades made of spring steel strip.

In order to enable a machining-down process, the clay must have a high penetration hardness at room temperature. Interfering properties appear especially with fine machining with blades. If, for example, the blade is repeatedly drawn over the clay surface, already removed chips are worked into the surface. So called “smears” arise, which occur with differing frequency and differing magnitude depending on the clay used and have an unfavourable influence on the surface quality.

When used in the design studio, the clay remains for different lengths of time in the heating cabinets, wherein the clay can already be processed after a heating phase of several hours. Smaller amounts of clay for the reworking the models sometime lie for several weeks in the heating cabinet. It is important, therefore, that the clay has good storage stability at 60° C., i.e. the clay must not display any exudation of the liquid phase, must not form a skin at the surface and the penetration hardness may change only slightly.

Thus, a clay for design modelling is known from DE 29720344 U1 which, apart from zinc soap as a consistency-producing filler, kaolin as a filler, vaseline, microwax, paraffin, white oil and dyes, also comprises hollow microspheres. It has proved to be a drawback with such clay according to the prior art that, with these mixtures, too small a time window for the application is accompanied by a raised viscidity in the cold state and, in addition, the chips arising in the paring-off of the model have a tendency towards smearing.

The problem of the invention, therefore, is to create a plasteline or industrial plasteline which does not have the aforementioned disadvantages. In particular, it is the problem to create a plasteline which has a good viscidity in the cold state and at the same time the number and size of the smeared chips can be reduced, without the positive properties such as a low penetration hardness, a good layer adhesion upon application and a lengthy time window for application (=malleability) of the plasteline being impaired, but rather contributing to their improvement.

This problem is solved with the features contained in claims 1, 9 and 10.

Advantageous embodiments and developments of the mixtures according to the invention are contained with the further claims.

Surprisingly, it has been shown that, by the addition of surfactants as components in plasteline, the penetration hardness can be lowered, and the time window for the application process can be lengthened. It has been shown that the problem posed is solved if the proportion of the surfactant amounts to from 0.1 to 4.0 wt. % in the plasteline. In a preferred embodiment, 0.15 to 3.0 wt. % surfactant is contained in the plasteline. A content of 0.20 wt. % to 2.00 wt. % is particularly preferred. Surprisingly, it has been shown that the effect of the surfactant used could be observed over the entire range.

A low penetration hardness—for example at 60° C.—means that the plasteline can flow more easily during application and therefore less force is required for the distribution.

For example, non-ionic surfactants such as 1-hexadecanol, ester of myristic acid and myristic alcohol, (C16-C18) fatty alcohol polygcolether, polyglycerin distearate and/or oxyethylated stearic acid polyglycerin ester may be mentioned by way of example as surfactants.

It is generally the case that the surfactants used according to the invention fall under the general term of amphiphilic molecules, which have at least one hydrophobic and at least one hydrophilic region.

The hydrophobic region of the surfactant consists of an alkyl group, which comprises between 8 and 34, in particular 14 and 18 carbon atoms. This region is to be attributed to the carbonic acids or alkanols.

In the hydrophilic region—such as the non-ionic surfactants mentioned by way of example above—there are alcohol groups, carbonic acid ester groups and/or ether groups. This region of the surfactants also originates either from the fatty acids or fatty alcohols or from glycerin or ethyl glycol.

Alternatively, other non-ionic, anionic, cationic and/or amphoteric surfactants can also be used, which differ in the hydrophilic region.

The hydrophilic regions of these surfactants would then be present constituted as follows.
1) Non-ionic surfactants: contain alcohols, carbonic acid esters, amides or ethers, which originate from fatty alcohol, fatty acid, glycerin, ethylene glycol, polypropylene glycol or glycosides;
2) anionic surfactants: contain carboxylates, sulphonates, sulphates and phosphates;
3) cationic surfactants: contain quaternary ammonium compounds;
4) amphoteric surfactants: contain quaternary ammonium compounds, carboxylates, sulphonates, sulphates, sulfoacetate and/or amido betaines;

For the individual surfactant groups, the following may be named by way of example:
non-ionic surfactants: Saccharose stearate and
N-(2hydroxyethyl)cocoa fatty acid amide;
anionic surfactants: sodium palmityl sulphate and sodium tetradecene sulfonate; cationic surfactants: distearyl dimethyl ammonium chloride;
amphoteric surfactants: cocoa fatty acid amido propyl betaine and disodium cocoa amphodiacetate;

Surprisingly, it has been shown that surfactants from the surfactant groups in the claimed range can be used mixed with one another.

It has proved to be advantageous when the plasteline has low hardness and a long time window for application, wherein the content of waxes and/or oils can then also be reduced. The effect of this is that the hardness of the plasteline then increases again to the usually desired level, wherein the time window for the application largely remains unaffected. But it has surprisingly also been shown that the viscidity of the cooled mixture diminishes, which in turn favourably leads to a reduction of so-called “smears”.

The employed binder can be present as wax, for example microwax or paraffin wax, as vaseline, as oil, as for example paraffin oil, and also as mixtures of the aforementioned materials. The proportion of the binder amounts to 10-60 wt. %, preferably 12-55 wt. %, and particularly preferably 15-50 wt. %.

As fillers, essentially inorganic and/or organic fillers are used, e.g. cellulose particles, native starches, talcum, aluminium hydroxide, alumina, sulphur, kieselguhr and/or clay powder meal, which have a grain size <250 μm, preferably less than 100 μm.

As further fillers, use can be made of inorganic or organic salts of the metals calcium, zinc, tin, magnesium or barium, such as for example calcium carbonate, calcium stearate, zinc oxide, zinc oleate, zinc oxide, magnesium carbonate or barium sulphate as well as mixtures of the salts.

Furthermore, so-called lightweight filler can also be used and mixed in as a filler. Examples of lightweight filler are hollow spheres, in particular hollow glass microspheres, e.g. from the firm 3M or PQ-Corporation. Depending on the content of lightweight fillers, a desired density can be adjusted which advantageously lies in the range from 0.3 to 1.1 g/ml. The size of commercially available lightweight fillers can also be freely selected, wherein their size advantageously lies in a range from 5 to 400 μm.

Glitter, metal effect pigments, pearled gloss pigments or mixtures of these materials can be present as further fillers, in order in this way to achieve particular optical effects.

As dyes, colourants or powder pigments can be used. As a selection of a multiplicity of possible colour pigments, mention may be made of iron oxide, iron hydroxide, carbon black, organic pigments and/or titanium dioxide.

The invention is to be represented in greater detail with the aid of several framework examples and an example of a formulation.

Framework example 1 - plasteline according to the invention

| | | |
|---|---|---|
| 10-60 | wt. % | binder (BM) |
| 0.1-4 | wt. % | surfactant (T) |
| 30-90 | wt. % | filler (FS) |
| 0-10 | wt. % | dye (FM) |
| 0-20 | wt. % | other additives (A) |

Framework example 2 - preferred composition

| | | |
|---|---|---|
| 12-55 | wt. % | binder |
| 0.15-3 | wt. % | surfactant |
| 35-85 | wt. % | filler |
| 0-10 | wt. % | dye |
| 0-20 | wt. % | other additives |

Framework example 3 - particularly preferred composition

| | | |
|---|---|---|
| 15-50 | wt. % | binder |
| 0.20-2 | wt. % | surfactant |
| 40-85 | wt. % | filler |
| 0-10 | wt. % | dye |
| 0-10 | wt. % | other additives |

Composition example 1 - industrial plasteline
according to the invention

| | | |
|---|---|---|
| 11 | wt. % | microwax (BM) |
| 11 | wt. % | paraffin wax (BM) |
| 0.9 | wt. % | alkyl polyethylene glycol ether (T) |
| 11 | wt. % | alumina (FS) |
| 8.4 | wt. % | native starch (FS) |
| 11 | wt. % | hollow glass spheres (FS) |
| 11 | wt. % | Kieselguhr (FS) |
| 24 | wt. % | calcium stearate (FS) |
| 8.5 | wt. % | oil (BM) |
| 3.2 | wt. % | iron oxide red pigment (FM) |

Composition example 2 - industrial plasteline
according to the invention

| | | |
|---|---|---|
| 14 | wt. % | microwax (BM) |
| 10 | wt. % | paraffin wax (BM) |
| 8.5 | wt. % | paraffin oil (BM) |
| 1.5 | wt. % | oxyethylated stearic acid polyglycerin ester (T) |
| 14 | wt. % | alumina (FS) |
| 9 | wt. % | talcum (FS) |
| 15 | wt. % | aluminium hydroxide (FS) |
| 8 | wt. % | Kieselguhr (FS) |
| 16 | wt. % | calcium stearate (FS) |
| 4.0 | wt. % | carbon black (FM) |

A desired consistency of the mixture can be adjusted without problem by varying the binder content.

Prior art - composition according to DE 29720344 U1

| | | |
|---|---|---|
| 20.1 | wt. % | hollow microspheres |
| 34.5 | wt. % | zink soap |
| 1.9 | wt. % | fine koalin |
| 1.9 | wt. % | talcum |
| 9 | wt. % | vaseline |
| 13 | wt. % | microwax |
| 14.5 | wt. % | paraffin |
| 3.6 | wt. % | white oil |
| 1.5 | wt. % | iron oxide, brown |

The present invention is intended to be explained in greater detail with the aid of the following table.

TABLE 1
Reduction of the penetration hardness by the use of surfactants

| | Penetration hardness | Penetration hardness |
|---|---|---|
| | at 23° C. (truncated | at 60° C. (truncated |
| | cone)/g | cone)/g |
| Mixture according to | 3440/1140 | 160/30 |
| the invention | | |
| Formulation example 1 | | |
| Mixture according to | 4520/1560 | 230/80 |
| formulation example | | |
| without surfactant | | |

The method for measuring the penetration hardness is standardised by the US American ASTM (American Society for Testing Materials). (ASTM D 1321-16a/ASTM D 937-07(2019)). There are also corresponding standards in other countries such as the British standard BS EN 1426:2015-07-31 or DIN 51579:2010-03.

It has been shown, as can be seen from table 1, that the penetration hardness of the mixture according to the invention, which has a surfactant component, is less than in the case of the mixture of the same composition without a surfactant.

A lower penetration hardness at 60° C. means that the plasteline flows more easily when applied and less force is required for the distribution on the model.

TABLE 2
Duration of malleability (=time window for application)

| | Application test (scale |
|---|---|
| | from −6 to +6 Hardness at |
| | 60° C./duration of malleability |
| Formulation example without | 0/0 |
| surfactant (reference) | |
| Mixture according to the | −3/+4 |
| invention | |
| Formulation example 1 | |
| Mixture according to St · d · T | −3/−2 |
| DE 29720344 U1 | |

Malleability or duration of malleability is to be understood as a time window for the application, in which the plasteline can be processed or applied on the model.

There is no mechanically standardised method for the tests for measuring the malleability, but there is a haptic test. For this purpose, the mixtures to be compared are heated to 60° C. Two samples of the mixtures of equal size are then taken into each hand and slowly kneaded. If the mixtures differ in the time window for application, then this is shown in this test by a different length of time after which the mixtures become superficially brittle and crazed.

As a result of the longer time window for application, it enables the user to take larger amount of plasteline from the oven, which saves time and cost.

This advantage of the extended time window is also to be seen as a great advantage in machine processing, because in such machines the heated plasteline has to be transported over a lengthy distance in tube or other feed systems.

A method for producing such modelling mixtures as described below.
Step 1: produce binder or binder mixture and mix at a temperature greater than room temperature until homogeneous
Step 2: add surfactant and mix till homogeneous
Step 3: add fillers and dyes and again mix until the mixture is homogeneous
Step 4: add lightweight fillers and again mix until homogeneous
Step 5: optionally, vent the mixture under vacuum

The plasteline according to the invention finds use in the production of design models in motor vehicle construction. Such design models are produced up to a scale of 1:1. The application of such mixtures can on the one hand the applied manually, but also mechanically.

In both types of application, it has proved to be advantageous if the plasteline has a proportion of surfactant.

Especially with mechanical application, an improvement was surprisingly found in the further processing of the basic model. The removal of excess plasteline material by the machining method of milling may be cited as further processing by way of example.

1-9. (canceled)

10. A plasteline, comprising: a binder; a filler; and at least one surfactant.

11. The plasteline according to claim 10, wherein the content of the at least one surfactant amounts to 0.10 to 4.0 wt. % in the plasteline.

12. The plasteline according to claim 11, wherein the content of the at least one surfactant amounts to 0.15 to 3.0 wt % in the plasteline.

13. The plasteline according to claim 13, wherein the content of the at least one surfactant amounts to 0.02 to 2.0 wt % in the plasteline.

14. The plasteline according to claim 10, wherein the at least one surfactant is from the group of amphiphilic molecules, wherein the amphiphilic molecules have a hydrophobic and at least one hydrophilic region, and the hydrophobic region of the at least one surfactant consists of an alkyl group, which comprises between 8 and 34 carbon atoms.

15. The plasteline according to claim 14, wherein the hydrophobic region of the at least one surfactant consists of an alkyl group, which comprises between 14 and 18 carbon atoms.

16. The plasteline according to claim 10, wherein the at least one surfactant is present as a non-ionic, anionic, cationic and/or amphoteric surfactant.

17. The plasteline according to claim 16, wherein the at least one surfactant comprises hydrophilic regions, wherein the hydrophilic regions contain alcohols, carbonic acid ester, amides or ethers, which originate from fatty alcohol, fatty acid, glycerin, ethylene glycol, polypropylene glycol or glycosides, wherein the hydrophilic region of an anionic surfactant contains carboxylates, sulphonates, sulphates and phosphates, wherein the hydrophilic region of a cationic surfactant contains quaternary ammonium compounds, and wherein the hydrophilic region of an amphoteric surfactant contains quaternary ammonium compounds, carboxylate, sulphonate, sulphate, sulfoacetate and/or amido betaines.

18. The plasteline according to claim 10, wherein the plasteline comprises

| | | |
|---|---|---|
| 10-60 | wt. % | binder (BM) |
| 0.1-4 | wt. % | surfactant (T) |
| 30-90 | wt. % | filler (FS) |
| 0-10 | wt. % | dye (FM) |
| 0-20 | wt. % | other additives (A) |

19. A method for producing a design model in motor vehicle construction, comprising producing the design model using a plasteline according to claim 10.

20. The method according to claim 19, including producing the model by mechanically applying the plasteline and mechanically removing excess clay.
